(19) United States
(12) Patent Application Publication
(10) Pub. No.: US 2020/0306875 A1
(43) Pub. Date: Oct. 1, 2020

(54) FRICTION STIR WELDING TOOL

(71) Applicant: HONDA MOTOR CO., LTD., Tokyo (JP)

(72) Inventors: Keisuke TSUTA, WAKO-SHI (JP); Mitsuru SAYAMA, WAKO-SHI (JP); Akiyoshi MIYAWAKI, WAKO-SHI (JP)

(21) Appl. No.: 16/833,027

(22) Filed: Mar. 27, 2020

(30) Foreign Application Priority Data
Mar. 29, 2019 (JP) 2019-068816

(51) Int. Cl. B23K 20/12

(52) U.S. Cl. CPC B23K 20/1255

(57) ABSTRACT

A friction stir welding tool includes a shoulder having a flat front end surface perpendicular to a rotation axis, and a probe protruding from the front end surface of the shoulder. The friction stir welding tool is configured to rotate the probe about the rotation axis, and embed the probe inside a workpiece during rotation of the probe to weld the workpiece. Protrusions and a recess are formed in the front end surface of the shoulder. The protrusions are positioned remotely from the probe, and configured to guide first softened material of the workpiece softened at the time of performing friction stir welding to the probe. The recess is positioned between the protrusions and the probe.

### CROSS-REFERENCE TO RELATED APPLICATION

This application is based upon and claims the benefit of priority from Japanese Patent Application No. 2019-068816 filed on Mar. 29, 2019, the contents of which are incorporated herein by reference.

### BACKGROUND OF THE INVENTION

### Field of the Invention

The present invention relates to a friction stir welding tool which welds a workpiece by rotating a probe about a rotation axis and embedding the probe inside the workpiece during rotation of the probe.

### Description of the Related Art

Japanese Laid-Open Patent Publication No. 2008-307606 discloses a friction stir welding tool including a shoulder having a flat front end surface perpendicular to a rotation axis and a probe protruding from the front end surface of the shoulder.

### SUMMARY OF THE INVENTION

However, in the case of providing a protrusion in a front end surface of a shoulder, for guiding softened material of a workpiece which has been softened at the time of performing friction stir welding of the workpiece, as the protruding length of the protrusion which protrudes from the front end surface of the shoulder increases, it becomes more efficient to guide the softened material to the probe. However, as the protruding length of the protrusion increases, the protrusion tends to be broken, or damaged more easily.

The present invention has been made taking such a problem into account, and an object of the present invention is to provide a friction stir welding tool in which it is possible to efficiently guide softened material to a probe, and eliminate or reduce the situations where a protrusion of a shoulder of the probe is broken or damaged.

According to an aspect of the present invention, a friction stir welding tool is provided. The friction stir welding tool includes a shoulder having a flat front end surface perpendicular to a rotation axis, and a probe protruding from the front end surface of the shoulder, wherein the friction stir welding tool is configured to rotate the probe about the rotation axis, and embed the probe inside a workpiece during rotation of the probe to weld the workpiece, and wherein a protrusion and a recess are formed in the front end surface of the shoulder, the protrusion is positioned remotely from the probe, and configured to guide softened material of the workpiece softened at time of performing friction stir welding to the probe, and the recess is positioned between the protrusion and the probe.

In the present invention, since the recess is formed between the protrusion in the front end surface of the shoulder and the probe, it is possible to reduce the protruding length of the protrusion, and increase the quantity (volume) of the softened material which can be stored between the protrusion and the recess. Accordingly, it is possible to efficiently guide the softened material to the probe efficiently, and eliminate or reduce the situations where the protrusion of the shoulder of the probe is broken or damaged.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a view schematically showing overall structure of a friction stir welding system including a friction stir welding tool according to an embodiment of the present invention;

FIG. 2 is a partial perspective view showing a friction stir welding tool;

FIG. 3A is a side view showing the friction stir welding tool in FIG. 2;

FIG. 3B is a view showing the friction stir welding tool in FIG. 2, where the friction stir welding tool is viewed from a front end;

FIG. 4 is a perspective view showing lap welding using the friction stir welding tool shown in FIG. 2; and

FIG. 5 is cross sectional view showing lap welding in FIG. 4.

### DESCRIPTION OF THE PREFERRED EMBODIMENTS

Hereinafter, a preferred embodiment of a friction stir welding tool according to the present invention will be described in relation to a friction stir welding system with reference to the accompanying drawings.

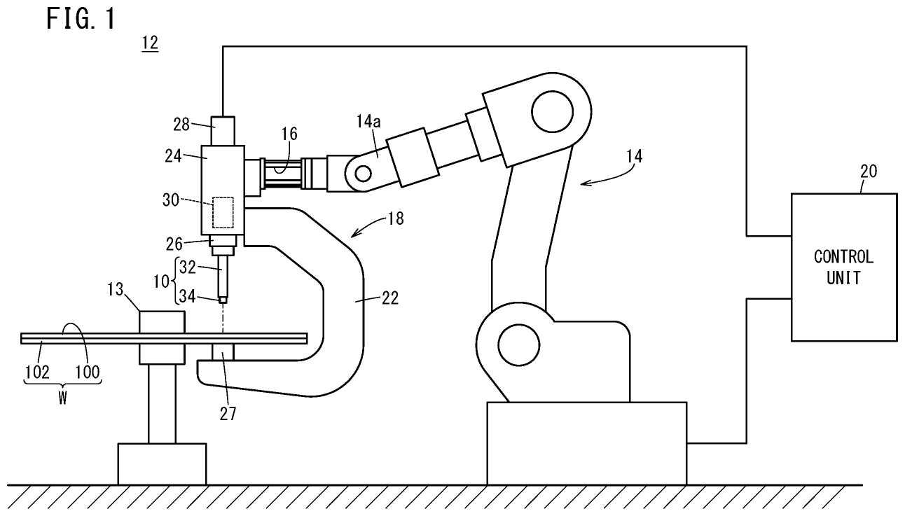

As shown in FIG. 1, a friction stir welding system 12 is configured to perform friction stir welding (FSW) of a workpiece W by, while rotating a friction stir welding tool 10 (hereinafter also referred to as the “welding tool 10”), pressing the friction stir welding tool 10 against the workpiece W.

For example, the workpiece W includes a first member 100 in the form of a plate, and a second member 102 in the form of a plate. In the state where the first member 100 and the second member 102 are stacked together, the workpiece W is fixed to a fixing base 13.

Each of the first member 100 and the second member 102 is made of metal material such as aluminum, magnesium, copper, iron, titanium, or alloy of these materials, etc. The first member 100 and the second member 102 may be made of the same material, or may be made of different materials. It should be noted that at least one of the first member 100 and the second member 102 may be made of resin material. The size and the shape of the first member 100 and the second member 102 may be determined as necessary.

The friction stir welding system 12 includes an industrial multi-joint robot 14, a welding device body 18 provided at a front end of a robot arm 14a of the robot 14 through a connector 16, the welding tool 10 detachably attached to the welding device body 18, and a control unit 20 which controls the entire system totally.

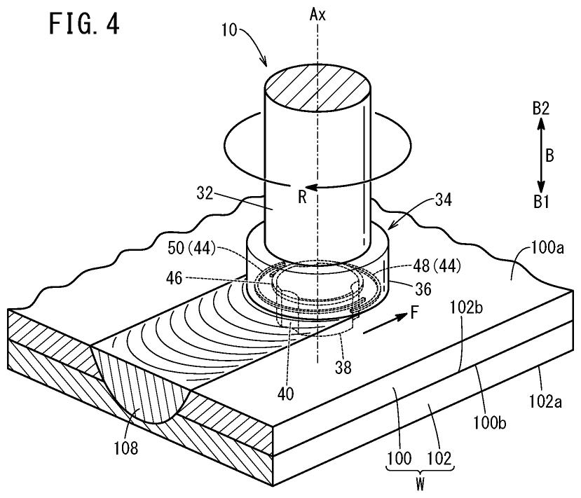

The robot 14 adjusts the position and the orientation of the welding device body 18 relative to the workpiece W to move the welding tool 10 relative to the workpiece W. Specifically, in the case of performing line welding of the workpiece W, the robot 14 adjusts the position and the orientation of the welding device body 18 in a manner that the welding tool 10 moves in a welding direction (in a direction indicated by an arrow F in FIG. 4) relative to the workpiece W. That is, the robot 14 functions as means for moving and tilting the welding tool 10.

The welding device body 18 includes a C-shaped support arm 22, a drive unit 24 provided at one end of the support arm 22, a chuck 26 provided for the drive unit 24 to clamp the welding tool 10, and a receiver member 27 provided at the other end of the support arm 22.

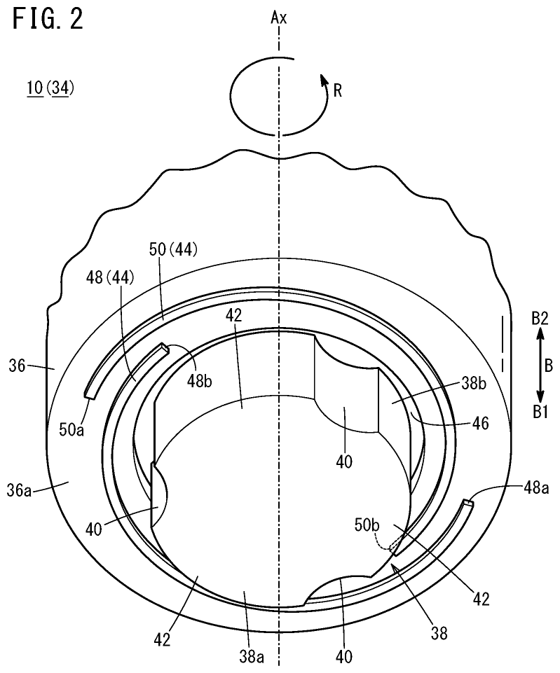

The drive unit 24 includes a rotary motor 28 for rotating the welding tool 10 attached to the chuck 26 in a predetermined rotation direction (in a direction indicated by an arrow R in FIG. 2), and an actuator 30 for moving the welding tool 10 back and forth in a direction of a rotation axis Ax (in a direction indicated by an arrow B in FIG. 2). At the time of performing friction stir welding of the workpiece W, the receiver member 27 is positioned opposite to the chuck 26 (welding tool 10) such that the workpiece W is positioned between the receiver member 27 and the chuck 26. The receiver member 27 receives a pressing force (pressure force) applied from the welding tool 10 to the workpiece W.

The welding tool 10 includes a substantially hollow-cylindrical holder 32 and a tool 34 detachably attached to the holder 32. The proximal end of the holder 32 is clamped by the chuck 26. The tool 34 can be attached to a front end of the holder 32 coaxially with the holder 32. The tool 34 is consumable. When the tool 34 is worn out as a result of friction stir welding, the tool 34 is replaced with new one.

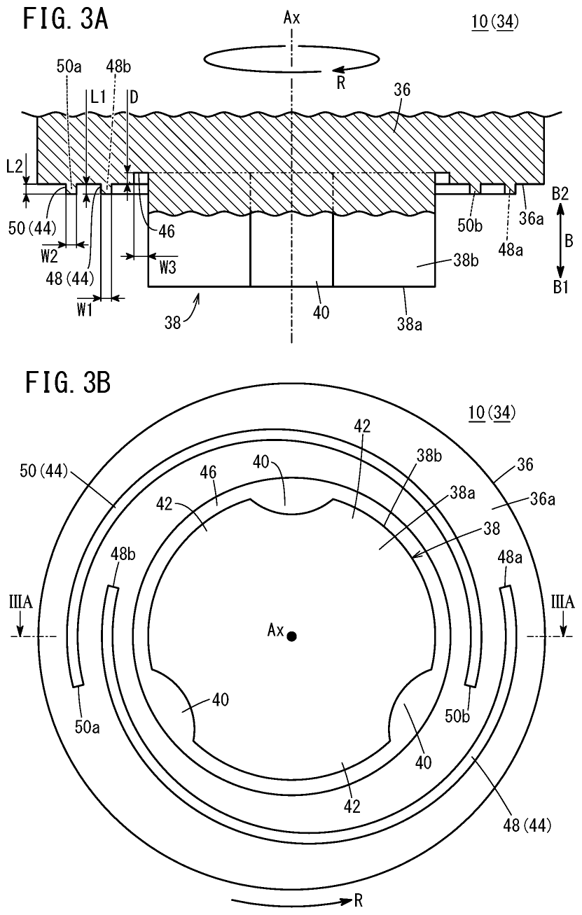

As shown in FIGS. 2 to FIG. 3B, the tool 34 includes a substantially cylindrical shoulder 36, and a small diameter probe 38 provided on a front end surface 36a of the shoulder 36. The welding tool 10 welds the workpiece W by rotating the probe 38 in the direction indicated by the arrow R about the rotation axis Ax and embedding the probe 38 inside the workpiece W during rotation of the probe 38.

The tool 34 is produced by machining (cutting) cylindrical metal material. It should be noted that the tool 34 may be produced by a method other than machining (e.g., by means of casting, stacking, etc.). Examples of materials suitably employed in the tool 34 include tool steels having hardness higher than that of the workpiece W, and having excellent heat resistance and wear resistance. It should be noted that the materials of the tool 34 are not limited to the tool steels, and can be determined as necessary.

The proximal end (end in a direction indicated by an arrow B2) of the shoulder 36 is detachably attached to the holder 32 (see FIG. 1). The front end surface 36a of the shoulder 36 (end surface in a direction indicated by an arrow B1) has a flat shape extending in a direction perpendicular to the rotation axis Ax (see FIGS. 2 and 3A).

The probe 38 protrudes from the front end surface 36a of the shoulder 36 in a front end direction (indicated by an arrow B1) (see FIGS. 2 and 3A). The probe 38 is provided coaxially with the shoulder 36. The outer diameter and the protruding length of the probe 38 can be determined as necessary depending of the shape, the size, the material, etc. of the workpiece W as a welding target.

The probe 38 has a cylindrical shape, and includes a front end surface 38a and an outer circumferential surface 38b. The front end surface 38a of the probe 38 is a flat surface. It should be noted that a recess depressed in a proximal end direction (in a direction indicated by an arrow 82) may be formed in the front end surface 38a of the probe 38.

The plurality of (three, in the illustrated embodiment) outer circumferential recesses 40 (side surface grooves) are formed in the outer circumferential surface 38b of the probe 38. The outer circumferential recesses 40 extend to the front end surface 38a along the rotation axis Ax of the probe 38. The plurality of outer circumferential recesses 40 are arranged at equal intervals of angle (at intervals of 120°, in the illustrated embodiment) in a circumferential direction of the probe 38 (see FIGS. 2 and 3B). The proximal end of each of the outer circumferential recesses 40 is positioned at the proximal end of the probe 38.

The probe 38 has claws 42 between the outer circumferential recesses 40 that are adjacent to each other in the circumferential direction of the probe 38. Stated otherwise, the number of the claws 42 of the probe 38 corresponds to the number of the outer circumferential recesses 40.

Protrusions 44 and a recess 46 are formed in the front end surface of the shoulder 36. The protrusions 44 are positioned remotely from the probe 38. The recess 46 is positioned between the protrusions 44 and the probe 38. The protrusions 44 are guide walls for guiding softened material (first softened material 104 described later) of the workpiece W softened at the time of performing friction stir welding to the probe 38.

The protrusions 44 include a first line protrusion 48 and a second line protrusion 50. As shown in FIG. 3B, the first line protrusion 48 extends in a line pattern in a manner to cover at least part of the probe 38 from the outside. Specifically, the first line protrusion 48 extends in a circular arc shape (e.g., semicircular shape). The first line protrusion 48 extends in a manner to cover the proximal end of the probe 38 in a circumferential direction over 180° or more.

The first line protrusion 48 is shifted toward one side with respect to the probe 38 in a manner that the space between one end 48a of the first line protrusion 48 (end positioned on the front side of the shoulder 36 in a rotation direction) and the probe 38 becomes larger than the space between another end 48b of the first line protrusion 48 (end positioned on the rear side of the shoulder 36 in the rotation direction) and the probe 38. Compared with the front end surface 38a of the probe 38, the protruding end of the first line protrusion 48 is positioned close to the proximal end (in the direction indicated by the arrow B2) (see FIG. 2 and FIG. 3A).

The second line protrusion 50 has the same structure as the first line protrusion 48. That is, the second line protrusion 50 extends in a line pattern in a manner to cover at least part of the probe 38 from the outside. Specifically, the second line protrusion 50 extends in a circular arc shape (e.g., semicircular shape). The second line protrusion 50 covers the proximal end of the probe 38 in the circumferential direction over 180° or more.

The second line protrusion 50 is shifted in a direction opposite to the first line protrusion 48, with respect to the probe 38 in a manner that the space between one end 50a (end positioned on the front side of the shoulder 36 in the rotation direction) of the second line protrusion 50 and the probe 38 becomes longer than the space between another end 50b (end positioned on the rear side of the shoulder 36 in the rotation direction) of the second line protrusion 50 and the probe 38. Compared with the front end surface 38a of the probe 38, the protruding end of the first line protrusion 48 is positioned close to the proximal end (in the direction indicated by the arrow B2) (see FIG. 2 and FIG. 3A).

The other end 50b of the second line protrusion 50 is positioned between one end 48a of the first line protrusion 48 and the probe 38. The other end 48b of the first line protrusion 48 is positioned between one end 50a of the second line protrusion 50 and the probe 38. That is, one end 48a of the first line protrusion 48 and the other end 50b of the second line protrusion 50 are overlapped with other in the radial direction of the shoulder 36. One end 50a of the second line protrusion 50 and the other end 48b of the first line protrusion 48 are overlapped with each other in the radial direction of the shoulder 36. The overlapping length of the first line protrusion 48 and the second line protrusion 50 can be determined as necessary.

As shown in FIG. 3A, the protruding length L1 of the first line protrusion 48 and the protruding length L2 of the second line protrusion 50 are the same. The line width W1 of the first line protrusion 48 and the line width W2 of the second line protrusion 50 are the same.

In FIGS. 2 to FIG. 3B, the recess 46 is provided in a manner that the recess 46 is connected to each of the outer circumferential recesses 40. The recess 46 is an annular groove extending around the probe 38. The recess 46 is provided at the border between the probe 38 and the shoulder 36.

As shown in FIG. 3A, the groove width W3 of the recess 46 is substantially the same as the line width W1 of the first line protrusion 48 and the line width W2 of the second line protrusion 50. It should be noted that the line width W3 may be broader than, or narrower than the line width W1 and the line width W2. The depth D of the recess 46 is substantially the same as the protruding length L1 of the first line protrusion 48 and the protruding length L2 of the second line protrusion 50. It should be noted that the size of the depth D may be larger than, or smaller than the size of the protruding lengths L1 and L2. The recess 46 is provided remotely from the first line protrusion 48 and the second line protrusion 50.

Next, an example of lap welding the first member 100 (e.g., iron plate) and the second member 102 (aluminum alloy plate) of the workpiece W together using the above described welding tool 10 will be described.

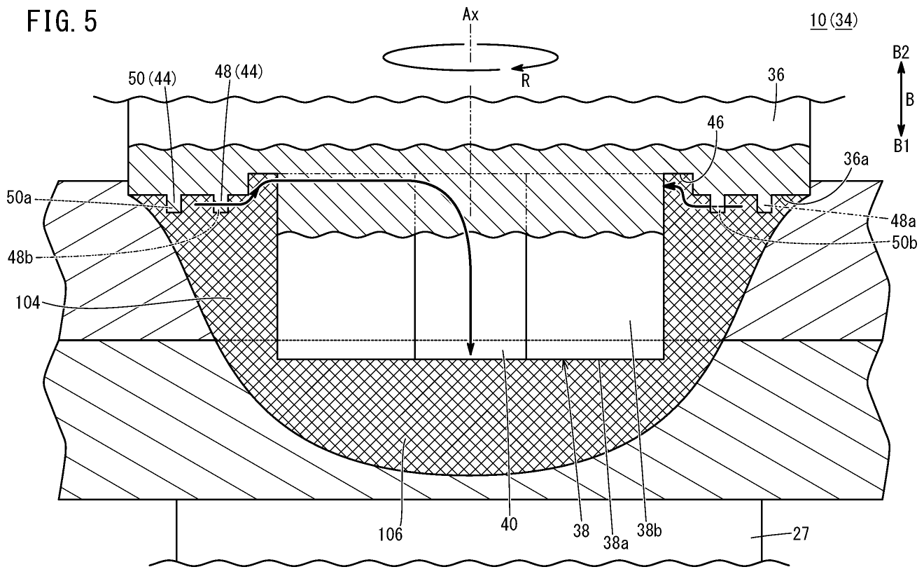

In this case, in FIG. 1, in the state where the first member 100 and the second member 102 are stacked together, the workpiece W is fixed to the fixing base 13. Specifically, as shown in FIGS. 4 and 5, one surface (first outer surface 100a) of the first member 100 is oriented toward the shoulder 36. The other surface (first inner surface 100b) of the first member 100 contacts one surface (second inner surface 102b) of the second member 102. The other surface (second outer surface 102a) of the second member 102 contacts the receiver member 27.

Then, the control unit 20 controls driving of the drive unit 24 to move the welding tool 10 toward the workpiece W (in the direction indicated by the arrow B1) while rotating the welding tool 10, and presses the front end surface 38a of the probe 38 against the first outer surface 100a of the first member 100.

As a result, as shown in FIG. 5, the probe 38 is inserted into the first member 100 while the probe 38 is machining the first member 100. At this time, since frictional heat is produced between the probe 38 and the first member 100, the portion of the first member 100 around the probe 38 is softened.

Then, when the front end surface 38a of the probe 38 reaches the second inner surface 102bof the second member 102, the probe 38 is inserted into the second member 102 while machining the second member 102. At this time, since frictional heat is produced between the probe 38 and the second member 102 and the frictional heat produced in the first member 100 is transmitted to the second member 102, the portion of the second member 102 around the probe 38 is softened. Then, the probe 38 is embedded in the workpiece W completely, and the front end surface 36a of the shoulder 36 is brought into contact with the first outer surface 100a of the first member 100.

The softened portion of the first member 100 (first softened material 104) and the softened portion of the second member 102 (second softened material 106) are dragged by rotation of the probe 38 to flow plastically, and stirred (mixed) together.

Specifically, when the probe 38 is rotated, the first softened material 104 present on the lateral side of the probe 38 flows inside the protrusion 44 (between the protrusion 44 and the probe 38) from a gap between one end 48a of the first line protrusion 48 and the other end 50b of the second line protrusion 50. Further, the first softened material 104 present on the lateral side of the probe 38 flows inside the protrusion 44 from a gap between one end 50a of the second line protrusion 50 and the other end 48b of the first line protrusion 48. Then, the first softened material 104 flows plastically in a spiral manner along the inner circumferential surface of the first line protrusion 48 and the inner circumferential surface of the second line protrusion 50 toward the probe 38. The first softened material 104 inside the protrusion 44 is taken into each of the outer circumferential recesses 40 through the recess 46. The first softened material 104 taken into each of the outer circumferential recesses 40 flows plastically in the front end direction of the probe 38 (in the direction indicated by the arrow B1). Accordingly, the first softened material 104 and the second softened material 106 are stirred together in the front end direction of the probe 38.

Then, as shown in FIG. 4, by moving the welding tool 10 in the welding direction (in the direction indicated by an arrow F) while maintaining rotation and pressing of the welding tool 10, the first member 100 and the second member 102 are welded together integrally by friction stir welding. As a result, a joint portion 108 (joint bead) is formed in the workpiece W.

In this case, the welding tool 10 according to the embodiment of the present invention offers the following advantages.

The protrusions 44 and the recess 46 are formed in the front end surface 36a of the shoulder 36. The protrusions 44 are guide walls for guiding the first softened material 104 of the workpiece W softened at the time of performing friction stir welding to the probe 38. The protrusions 44 are positioned remotely from the probe 38. The recess 46 is positioned between the protrusions 44 and the probe 38.

In the structure, it is possible to reduce the protruding length of the protrusions 44, and increase the quantity (volume) of the first softened material 104 which can be stored between the protrusions 44 and the recess 46. Accordingly, it is possible to efficiently guide the first softened material 104 to the probe 38 efficiently, and eliminate or reduce the situations where the protrusions 44 are broken or damaged.

The outer circumferential recesses 40 are formed in the outer circumferential surface 38b of the probe 38. The outer circumferential recesses 40 extend from the proximal end of the outer circumferential surface 38b to the front end surface 38a of the probe 38, and the recess 46 is connected to the outer circumferential recess 40.

In the structure, it is possible to guide the first softened material 104 in the recess 46 to the outer circumferential recesses 40 efficiently. Therefore, since it is possible to improve the efficiency of stirring the first softened material 104 and the second softened material 106 together, it is possible to obtain the suitable welding quality.

The recess 46 extends around the probe 38. In the structure, it is possible to efficiently increase the quantity (volume) of the first softened material 104 which can be stored in the recess 46.

The plurality of the outer circumferential recesses 40 are provided in the circumferential direction of the probe 38.

In the structure, it is possible to guide the first softened material 104 in the recess 46 smoothly to each of the outer circumferential recesses 40.

The recess 46 is provided at the border between the probe 38 and the shoulder 36.

In the simple structure, it is possible to connect the outer circumferential recesses 40 and the recess 46 together.

The protrusions 44 extend in a line pattern in a manner to cover at least part of the probe 38 from the outside.

In the structure, it is possible to smoothly guide the first softened material 104 to the probe 38 by the protrusions 44.

The present invention is not limited to the above described embodiments. It is a matter of course that various modifications may be made without departing from the gist of the present invention.

The welding tool 10 may be configured to perform lap welding of a workpiece W which comprises three or more plate members that are stacked together. The welding tool 10 may be used in butt welding, where end surfaces of two plate members are brought into abutment with each other, and the abutting portions are welded together by friction stir welding. The number of outer circumferential recesses 40 may be one, two, or four or more in the probe 38. The outer circumferential recesses 40 may not be provided in the probe 38.

The shape, the number, the size, and the positions of the protrusions 44 can be determined as necessary. The other end 48b of the first line protrusion 48 and the one end 50a of the second line protrusion 50 may be coupled together. The protrusion 44 may comprise three or more line protrusions, or may comprise a single line protrusion.

The shape, the number, the size, and the position of the recess 46 can be determined as necessary. That is, the recess 46 may be formed by providing a plurality of annular grooves having different diameters coaxially about the rotation axis Ax. The recess 46 may be formed by depressing the entire surface of part of the front end surface 36a of the shoulder 36 between the probe 38 and the protrusion 44 toward the proximal end. The recess 46 may be formed by providing a plurality of circular (perfectly circular or oval) or polygonal (e.g., triangular or quadrangular) depressed portions in the circumferential direction of the probe 38. The recess 46 may be provided remotely from the border between the front end surface 36a of the shoulder 36 and the probe 38.

The above embodiment is summarized as follows:

The above embodiment discloses the friction stir welding tool (10). The friction stir welding tool (10) includes the shoulder (36) having the flat front end surface (36a) perpendicular to the rotation axis (Ax), and the probe (38) protruding from the front end surface (36a) of the shoulder (36), wherein the friction stir welding tool (10) is configured to rotate the probe (38) about the rotation axis (Ax), and embed the probe (38) inside the workpiece (W) during rotation of the probe (38) to weld the workpiece (W), and wherein the protrusion (44) and the recess (46) are formed in the front end surface (36a) of the shoulder (36), the protrusion (44) is positioned remotely from the probe (38), and configured to guide the softened material (104) of the workpiece (W) softened at the time of performing friction stir welding to the probe (38), and the recess (46) is positioned between the protrusion (44) and the probe (38).

In the friction stir welding tool (10), the outer circumferential recess (40) may be formed in the outer circumferential surface (38b) of the probe (38), the outer circumferential recess (40) may extend from the proximal end of the outer circumferential surface (38b) to the front end surface (38a) of the probe (38), and the recess (46) may be configured to be connected to the outer circumferential recess (40).

In the friction stir welding tool (10), the recess (46) may extend around the probe (38).

In the friction stir welding tool (10), the outer circumferential recess (40) may comprise a plurality of outer circumferential recesses provided in the circumferential direction of the probe (38).

In the friction stir welding tool (10), the recess (46) may be provided at the border between the probe (38) and the shoulder (36).

In the friction stir welding tool (10), the protrusion (44) may extend in a line pattern in a manner to cover at least part of the probe (38) from the outside.

What is claimed is:

1. A friction stir welding tool comprising a shoulder having a flat front end surface perpendicular to a rotation axis, and a probe protruding from the front end surface of the shoulder, wherein the friction stir welding tool is configured to rotate the probe about the rotation axis, and embed the probe inside a workpiece during rotation of the probe to weld the workpiece, and
wherein a protrusion and a recess are formed in the front end surface of the shoulder;
the protrusion is positioned remotely from the probe, and configured to guide softened material of the workpiece softened at time of performing friction stir welding to the probe; and
the recess is positioned between the protrusion and the probe.

2. The friction stir welding tool according to claim 1, wherein an outer circumferential recess is formed in an outer circumferential surface of the probe, the outer circumferential recess extends from a proximal end of the outer circumferential surface to a front end surface of the probe; and
the recess is configured to be connected to the outer circumferential recess.

3. The friction stir welding tool according to claim 2, wherein the recess extends around the probe.

4. The friction stir welding tool according to claim 3, wherein the outer circumferential recess comprises a plurality of outer circumferential recesses provided in a circumferential direction of the probe.

5. The fiction stir welding tool according to claim 2, wherein the recess is provided at a border between the probe and the shoulder.

6. The fiction stir welding tool according to claim 1, wherein the protrusion extends in a line pattern in a manner to cover at least part of the probe from the outside.
